(19) United States
(12) Patent Application Publication
(10) Pub. No.: US 2026/0277908 A1
(43) Pub. Date: Sep. 17, 2026

(54) BOOKMARKING FOR TRAINED MODEL-ASSISTED DATABASE MANAGEMENT SYSTEMS

(71) Applicant: SAP SE, Walldorf (DE)

(72) Inventors: Wolfgang Dittrich, Heidelberg (DE); Christian Conradi, Walldorf (DE)

(21) Appl. No.: 19/081,216

(22) Filed: Mar. 17, 2025

(51) Int. Cl. G06F 16/2455; G06F 16/2457; H04L 51/02

(52) U.S. Cl. CPC G06F 16/24552; G06F 16/24573; H04L 51/02

(57) ABSTRACT

Various examples are directed to systems and methods for querying a database management system. A system may receive a first chat tool input message from a user and provide the first chat tool input message as input to a trained computerized model. The system may determine a first output of the trained computerized model based on the chat tool input message indicates a first query to the database management system. The system may receive, from the database management system, first query response data in response to the first query. Based on the determining that the first output of the trained computerized model indicates the first query to the database management system, the system may generate comprising the first chat tool input message, the first query response data, and user metadata describing the user.

### BACKGROUND

A database management system (DBMS) can be implemented as part of a suite of software applications that execute together. For example, the DBMS may support various client processes that utilize the DBMS to manage data. In some examples, a DBMS is implemented with a suite of processes that implement an enterprise resource planning (ERP) software solution. An ERP software solution may include one or more ERP applications. The ERP applications execute in conjunction with the DBMS to manage various different aspects of business operations. An example ERP software solution is the S/4 HANA product available from SAP SE of Walldorf, Germany.

### BRIEF DESCRIPTION OF DRAWINGS The present disclosure is illustrated by way of example and not limitation in the following figures.

FIG. 1 is a diagram showing one example of an environment comprising an enterprise resource planning (ERP) system and a chat system for supporting users of the ERP system.

FIG. 2 is a flowchart showing one example of a process flow that may be executed by the chat system to generate bookmark data.

FIG. 3 is a flowchart showing one example of a process flow that may be executed by the chat system of FIG. 1 to store bookmark data describing an interaction between a user and the chat system of FIG. 1.

FIG. 4 is a flowchart showing one example of a process flow that may be executed by the chat system of FIG. 1 to respond to a user chat tool input message, for example, utilizing bookmark data.

FIG. 5 is a flowchart showing one example of a process flow that may be executed in the environment of FIG. 1 to respond to a chat tool input message from a user by storing bookmark data.

FIG. 6 is a flowchart showing one example of a process flow that may be executed in the environment of FIG. 1 to respond to a chat tool input message with stored bookmark data.

FIGS. 7-10 are diagrams showing examples of a user interface screens that may be provided to a user by the chat system 102 of FIG. 1.

FIG. 11 is a block diagram showing one example of a software architecture for a computing device.

FIG. 12 is a block diagram of a machine in the example form of a computer system within which instructions may be executed for causing the machine to perform any one or more of the methodologies discussed herein.

### DETAILED DESCRIPTION

Enterprise resource planning (ERP) applications perform various application processes. For example, an ERP application supporting a human resources operation may perform application processes including, for example, storing/accessing employee records, generating payroll, managing benefits, and/or the like. An example ERP application supporting accounting may use records managed by the database management application to perform various application processes such as, for example, posting transactions, reconciling accounts, and/or the like. An ERP application supporting operations may be used to perform various different application processes such as, for example, generating purchase orders, generating shipping orders, generating invoices, and/or the like.

ERP applications may utilize tables at the DBMS to store various enterprise data. For example, tables at the DBMS may be divided into rows and columns. Each row of a table may be referred to as a record. Each record may have multiple fields, where each field of a record corresponds to a column of the table including the record. Consider the example human resources ERP application described above. Such an ERP application may utilize an example employee table at the DBMS having records corresponding to employees and columns/fields corresponding to employee attributes such as, name, address, position, salary, and/or the like.

Some ERP applications utilize trained computerized models as a user aid. For example, a trained computerized model, such as a large language model (LLM) may be used to implement a chat tool for the user. A user may provide input messages to the chat tool. The input messages may include questions about matters managed by the ERP application. The chat tool may utilize the trained computerized model to analyze the chat tool input messages provided by the user and generate appropriate outputs. The outputs may include, for example, additional questions for the user and/or queries against a DBMS associated with the ERP application.

Consider an example in which an ERP user would like to generate a purchase order using an ERP application. The user may generate a chat tool input message indicating that the user would like to generate a purchase order. The trained computerized model may generate a response requesting that the user provide additional information for generating the purchase order. The user may provide an additional chat tool input message describing the requested additional information. If the trained computerized model determines that all information for generating the purchase order has been provided, it may prompt an action at a DBMS or other ERP backend system to generate the purchase order using the information provided by the user. The trained computerized model may prompt an action at the DBMS via an Application Programming Interface (API). If the trained computerized model determines that additional information is still required, its dialogue with the user may continue until all information is obtained.

Consider another example in which an ERP user would like to access specific invoices from the ERP application. The user may provide a chat tool input message describing the desired invoices. The trained computerized model may determine whether the information provided by the user is sufficient to identify the requested invoices. If not, the trained computerized model may generate one or more questions for the user. The user may provide additional chat tool input messages including the requested information. If the trained computerized model determines that still more information is needed, it may pose additional questions to the user. When sufficient information has been provided, the trained computerized model may generate a query against the DBMS or other backend system of the ERP application (e.g., via an API) to return the invoices requested by the user.

It is common in an ERP application environment for a user to look up the same information or perform the same actions multiple times. For example, when a browser-based user interface is used, a user may bookmark a particular request allowing the user to return to the request and re-access the results at a later time.

When using a chat tool based on a trained computerized model, however, recalling past queries or actions can be more complicated. For example, the trained computerized model may not always provide the same response to the same input messages. This may be due to changes in the data stored at the DBMS, changes to the underlying model and/or may be due to properties of the trained computerized model itself. As a result, a user who saves or bookmarks a particular input message to a trained computerized model chat tool may not consistently receive the same result.

Also, interactions between users and chat tools may consist of exchanged messages. The response of the trained computerized model may depend not only on the most recently submitted chat tool input message but also on previous chat tool input messages and previous trained computerized model outputs that are part of the same interaction. Accordingly, even if the trained computerized model was to provide consistent results, it may be necessary to remember a sometimes complex combination of chat tool input messages in their original order.

Various examples address these and other challenges utilizing a chat tool with bookmarking. The chat tool may process chat tool input messages received from users, for example, by a chatbot client. The chat tool may provide the chat tool input messages to a trained computerized model, such as an LLM. The trained computerized model may generate questions to be directed to the user and/or a query to be directed to a DBMS that may be implemented at an ERP system.

The chat tool may comprise a bookmark tool. The bookmark tool may trigger when the output of the trained computerized model indicates that a query is to be made to the DBMS (e.g., via an API). When the trained computerized model output indicates a query to the DBMS, the chat tool may direct the indicated query to the DBMS. The bookmark tool may generate bookmark data for the interaction. The bookmark data may comprise the most recent chat tool input message, response data describing a response of the DBMS to the query, and context data describing the context of the interaction between the user and the chat tool. The context data may describe, for example, a date of the interaction, a time of the interaction, a system used by the user to access the ERP application, and/or the like. The context data may also include user metadata describing the user such as, for example, a role associated with the user, a location of the user, a source system from which the user accessed the chat tool, and/or the like. Also, in some examples, the bookmark data may comprise at least one prior chat tool input message provided by the user as part of a string of messages from the user.

The bookmark data may be stored. When the user has a subsequent interaction with the chat tool, the bookmark tool may compare chat tool input messages to existing bookmark data. If the bookmark tool determines that one or more chat tool input messages correspond to an existing instance of bookmark data, the bookmark tool may prompt the user to receive all or part of the identified instance of bookmark data. The bookmark data may be provided in addition to or instead of making an additional query to the ERP and/or DBMS. In this way, the user of the chat tool may enjoy the benefits of the trained computerized model chat tool while also having access to potentially useful data. Further, user interactions that can be serviced using bookmark data may not require additional queries to the ERP and/or DBMS, which may reduce the query load at the ERP/DBMS.

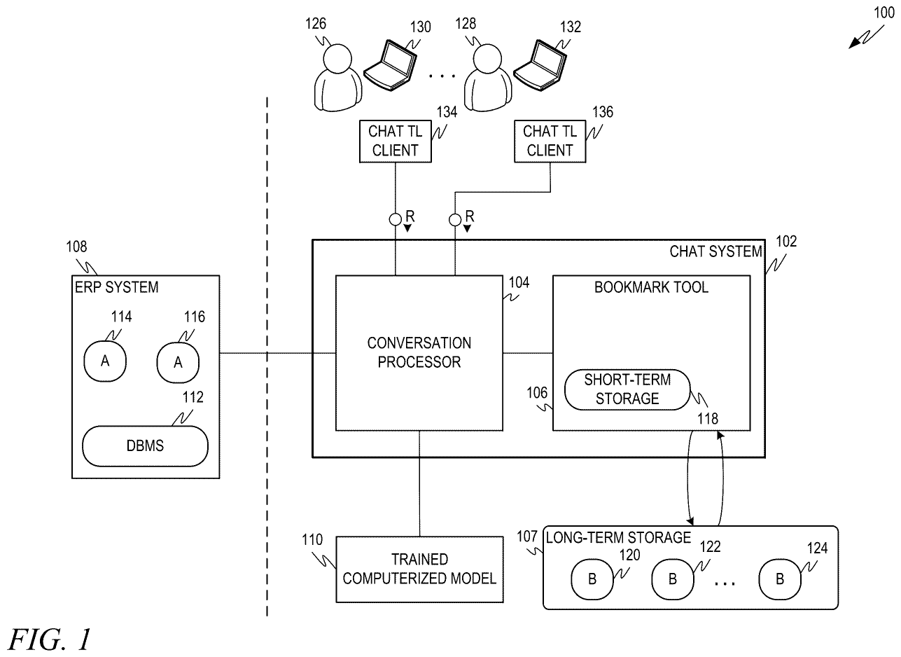

FIG. 1 is a diagram showing one example of an environment 100 comprising an ERP system 108 and a chat system 102 for supporting users 126, 128 of the ERP system 108. The ERP system 108 executes ERP applications 114, 116 and a DBMS 112. The ERP applications 114, 116 may be any suitable ERP application such as, for example, an operations management application, a human resources application, an accounting application, and/or the like.

Example ERP applications include an analytics software solution such as the SAP® Analytics Cloud application available from SAP SE of Walldorf, Germany, a human capital management software solution such as SAP SuccessFactors®, also available from SAP SE of Walldorf, Germany, a project management software solution such as SAP Portfolio and Project Management (PaPM), also available from SAP SE of Walldorf, Germany. Also, although two ERP applications 114, 116 are shown in FIG. 1, it will be appreciated that the ERP system 108 may execute more or fewer ERP applications. The DBMS 112 may manage and implement one or more databases storing data utilized by the ERP applications 114, 116.

In some examples, the ERP system 108 and/or the chat system 102 are implemented in a cloud environment, such as, for example, a public cloud environment or a private cloud environment. In a private cloud environment, the customer enterprise may provide executables and other files to implement the ERP system 108 and/or chat system 102. In a public cloud environment, users associated with the customer enterprise are provided with access to the ERP system 108 and/or chat system 102 through one of a number of tenancies. Each tenancy may be associated with one or more database clients. A software provider enterprise may provide executables and other files to implement the ERP system 108 and/or chat system 102 and, in some examples, may also maintain the ERP system 108 and the various tenancies. In some examples, the ERP system 108 and/or chat system 102 is an on-premises system implemented, for example, by the customer enterprise.

Users 126, 128 may access the ERP system 108 via the chat system 102 utilizing user computing devices 130, 132. The user computing devices 130, 132 may be any suitable computing device such as, for example, a mobile computing device, a laptop computing device, a desktop computing device, and the like. In some examples, the user computing devices 130, 132 may execute respective chat tool clients 134, 136. Chat tool clients may interface with the chat system 102 to provide the users 126, 128 with functionality of the ERP applications 114, 116 executing at the ERP system 108.

The chat system 102 may comprise various components including, for example, a conversation processor 104 and a bookmark tool 106. The conversation processor 104 and bookmark tool 106 may include executable code that is executed at the chat system 102. The chat system 102 may be in communication with a trained computerized model 110 and a long-term storage 107. The trained computerized model 110 may be an LLM, for example, as described herein. The trained computerized model 110 may be executed by the chat system 102 and/or by another system in communication with the chat system 102. In some examples, the trained computerized model 110 is executed in a public cloud environment where it is accessed by the chat system 102. The long-term storage 107 may include any suitable database, or other persistent storage for storing bookmark data 120, 122, 124. In some examples, the long-term storage 107 is implemented using one or more data storage devices of the chat system 102. Also, in some examples, the long-term storage 107 is implemented using a remote system such as, for example, a cloud-implemented storage service.

Users 126, 128 may interact with the ERP system 108 and its ERP applications 114, 116 by providing chat tool input messages through the chat tool clients 134, 136 to the chat system 102. The conversation processor 104 of the chat system 102 may receive incoming chat tool input messages. The conversation processor 104 may provide the chat tool input messages as input to the trained computerized model 110. For example, the conversation processor 104 may cause the trained computerized model 110 to execute using the incoming chat tool input message as all or part of the input of the trained computerized model 110. This may prompt the trained computerized model 110 to generate an output.

The output of the trained computerized model may indicate a query to the DBMS 112 and/or text data describing a user question. If the output of the trained computerized model 110 includes user question text data, the conversation processor 104 may provide the user question text data to the requesting user 126, 128. This may prompt the requesting user 126, 128 to provide an additional chat tool input message or messages. When the output of the trained computerized model 110 indicates a query to the DBMS 112, the conversation processor 104 may provide the query to the DBMS 112 and receive query response data (e.g., via an API). The conversation processor 104 may provide the query response data to the requesting user 126, 128.

The bookmark tool 106 may monitor chat tool input messages and corresponding outputs of the trained computerized model 110. When the bookmark tool 106 determines that an output of the trained computerized model 110 indicates a query to be executed at the DBMS 112, the bookmark tool 106 may generate bookmark data 120, 122, 124 describing the interaction between the user 126, 128 and the trained computerized model 110. Each instance of bookmark data 120, 122, 124 may comprise at least one chat tool input message provided by the user 126, 128, query response data generated by the DBMS 112 in response to the query, and context data describing the context of the query.

The bookmark tool 106 may also monitor chat tool input messages received from the user 126, 128. The bookmark tool 106 may compare chat tool input messages to bookmark data 120, 122, 124. When the bookmark tool 106 determines that some or all of an instance of bookmark data 120, 122, 124 is responsive to a chat tool input message provided by a user 126, 128, it may cause the chat system 102 to prompt the user 126, 128. The user 126, 128 may be prompted to indicate whether the user would like to receive the relevant bookmark data 120, 122, 124 or make a new query of the DBMS 112. If the user 126, 128 determines to receive relevant bookmark data 120, 122, 124, the bookmark tool 106 may provide the relevant bookmark data 120, 122, 124 to the conversation processor 104 which may, in turn, provide the bookmark data 120, 122, 124 to the user 126, 128.

In some examples, the bookmark tool 106 is configured to generate a vector embedding of instances of bookmark data 120, 122, 124. Vector embedding may be performed in any suitable manner. In some examples, instances of bookmark data 120, 122, 124 are provided to a trained computerized model. The output of the model may be a vector embedding of the input instance of bookmark data 120, 122, 124. The model may be or include, for example, an autoencoder model, the convolution model, a principal component analysis model, a T-distributed stochastic neighbor embedding (t-SNE), and/or the like.

In some examples, the bookmark tool 106 is configured to cache newly-generated bookmark data at a short-term storage 118. The short-term storage 118 may be implemented in a random access memory (RAM), or other data storage accessible to the chat system 102. Bookmark data 120, 122, 124 may remain at the short-term storage 118, for example, until the user 126, 128 reacts to the query response data included in the instance bookmark data 120, 122, 124. For example, if the user 126, 128 uses the query response data to access and ERP application 114, 116 or otherwise engages with the query response data, the bookmark tool 106 may determine that the newly generated bookmark data 120, 122, 124 is relevant to the user and may, therefore, move the bookmark data 120, 122, 124 from the short-term storage 118 the long-term storage 107.

The long-term storage 107 may also be a memory, or other persistent storage accessible to the chat system 102. In some examples, the long-term storage 107 is a cloud-implemented storage service. Moving the bookmark data 120, 122, 124 from the short-term storage 118 to the long-term storage 107 may include writing the bookmark data 120, 122, 124 to the long-term storage 107 and clearing the same bookmark data 120, 122, 124 from the short-term storage 118. In some examples, a vector embedding of an instance of bookmark data 120, 122, 124 is generated after it is determined to move the instance of bookmark data 120, 122, 124 to the long-term storage 107.

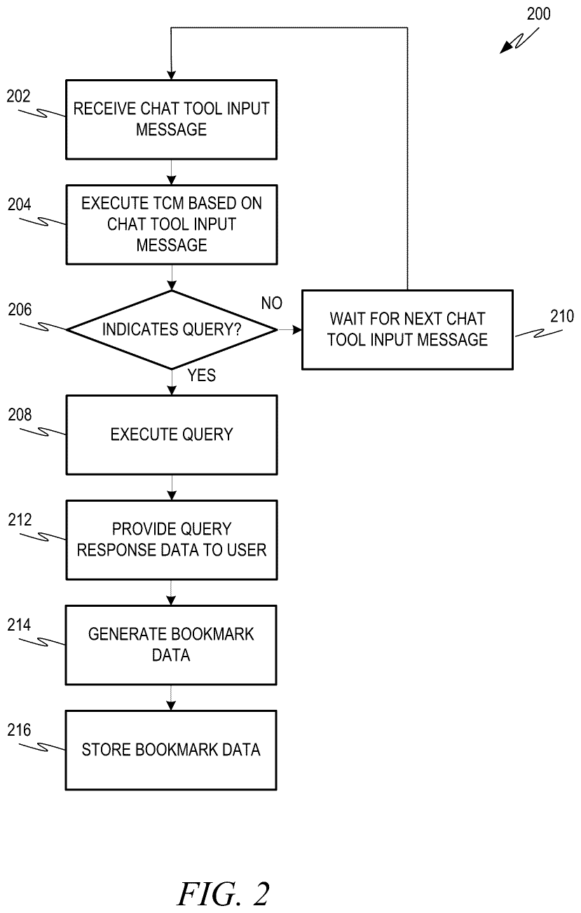

FIG. 2 is a flowchart showing one example of a process flow 200 that may be executed by the chat system 102 to generate bookmark data 120, 122, 124. At operation 202, the chat system 102 (e.g., the conversation processor 104) may receive a chat tool input message generated by a user 126, 128. For example, the chat tool input message may be received via a chat tool client 134, 136. At operation 204, the chat system 102 (e.g., the conversation processor 104) executes the trained computerized model 110 using the chat tool input message as some or all of the input to the trained computerized model 110. The trained computerized model 110 may generate an output that is based on the chat tool input message.

At operation 206, the chat system 102 determines if the output of the trained computerized model 110 indicates a query of the DBMS 112. In some examples, the output of the trained computerized model 110 may indicate a query of the DBMS 112 and/or may comprise user question text describing a question to be posed to the user 126. For example, user question text may prompt the user to provide additional information that may be used to by the trained computerized model to determine or suggest the query of the DBMS 112. If the output of the trained computerized model 110 indicates user question text, the user question text may be provided to the user. If the output of the trained computerized model 110 does not indicate a query of the DBMS 112, the chat system 102 may, at operation 210, wait for a next chat tool input message from the user 126, 128. The next chat tool input message, when received, may be processed as described with respect to operation 202.

If the output of the trained computerized model 110 does indicate a query of the DBMS, the chat system 102 may, at operation 208, execute the query at the DBMS 112. This may result in query response data. At operation 212, the chat system 102 (e.g. the conversation processor 104 thereof) may provide the user 126, 128 with a chat tool reply message including all or part of the query response data. At operation 214, the chat system 102 (e.g. the bookmark tool 106 thereof) may generate an instance of bookmark data 120, 122, 124 describing the transaction. The instance of bookmark data 120, 122, 124 may comprise the chat tool input message and the query response data. The bookmark data 120, 122, 124 may also comprise context data describing the interaction between the user and the chat system 102 that resulted in the query.

This may include, for example, data describing the user 126, 128 and data describing the user computing device 130, 132, chat tool client 134, 136, or other system through which the user 126, 128 accessed the chat system 102. The context data may also describe, for example, a role associated with the user, a date of the chat tool input message, a time of the chat tool input message, a location of the user, and/or the like.

At operation 216, the chat system 102 (e.g., the bookmark tool 106 thereof) may store the instance of bookmark data 120, 122, 124 generated at operation 214. In some examples, this includes initially storing the bookmark data 120, 122, 124 at short-term storage 118. Depending on the response of the user 126, 128 to the query response data, the bookmark tool 106 may then move the bookmark data 120, 122, 124 to long-term storage 107 and/or delete it. The chat system 102 may also, in some examples, generate a vector embedding of an instance of bookmark data 120, 122, 124. In some examples, the storing of the instance of bookmark data 120, 122, 124 may include storing the vector embedding.

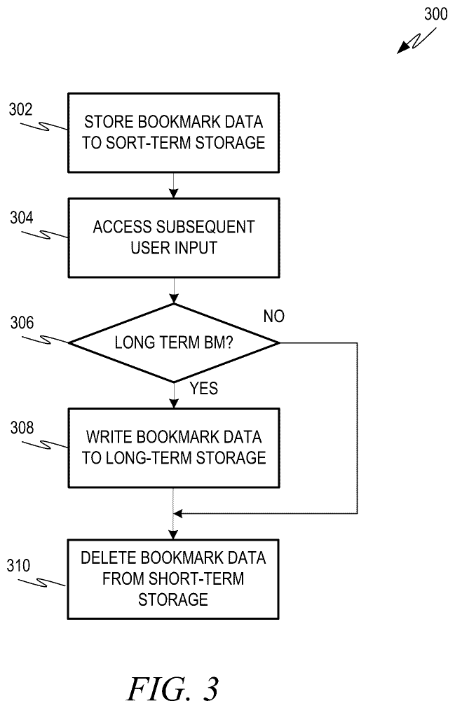

FIG. 3 is a flowchart showing one example of a process flow 300 that may be executed by the chat system 102 (e.g. the bookmark tool 106 thereof) to store bookmark data 120, 122, 124 describing an interaction between a user 126, 128 and the chat system 102. For example, FIG. 3 shows one example way of executing the operation 214 of the process flow 200.

At operation 302, the chat system 102 may store an instance of bookmark data 120, 122, 124 at short-term storage 118. At operation 304, the chat system 102 may access subsequent input from the user 126, 128. The subsequent input may describe the user's reaction to the query response data included with the instance of bookmark data 120, 122, 124. At operation 306, the chat system 102 may determine whether to move the instance of bookmark data 120, 122, 124 to long-term storage 107 or to delete it. This determination may be made based on the subsequent user input accessed at operation 304. If the subsequent user input indicates that the user found the query response data to be useful, then the corresponding instance of bookmark data 120, 122, 124 may be moved to long-term storage 107. For example, if the user selects a link from the query response data, it may indicate that the user found the query response data to be useful and that it should be stored in long-term storage 107. On the other hand, if the user response to the query response data by providing another chat tool input message requesting different data, it may indicate that the user 126, 128 did not find the query response data useful, indicating that the corresponding bookmark data 120, 122, 124 should not be stored at long-term storage 107.

If the chat system 102 determines to store the instance of bookmark data 120, 122, 124 at long-term storage 107, it may write the instance of bookmark data 120, 122, 124 to the long-term storage 107 at operation 308. In some examples, the chat system 102 makes a vector embedding of the instance of bookmark data 120, 122, 124. The vector embedding may be stored to the long-term storage 107 with the instance of bookmark data 120, 122, 124. If the chat system determines not to store the instance of bookmark data 120, 122, 124 at long-term storage, and/or in conjunction with moving the bookmark data to the long-term storage, the chat system wanted to make delete the bookmark data from the short-term storage at operation 310.

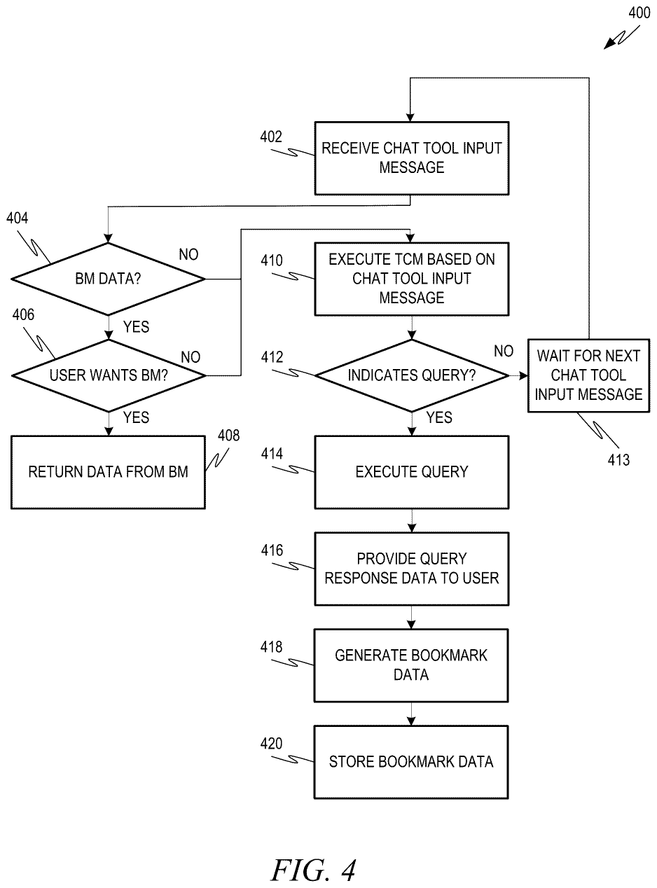

FIG. 4 is a flowchart showing one example of a process flow 400 that may be executed by the chat system 102 to respond to a user chat tool input message, for example, utilizing bookmark data 120, 122, 124. At operation 402, the chat system 102 (e.g., the conversation processor 104) may receive a chat tool input message generated by a user 126, 128. For example, the chat tool input message may be received via a chat tool client 134, 136.

At operation 404, the chat system 102 (e.g., the conversation processor 104 and/or bookmark tool 106) determines if there is a stored instance of bookmark data 120, 122, 124 that would be responsive to the chat tool input message received at operation 402. In some examples, this involves generating a vector embedding of the chat tool input message received at operation 402 and comparing it to vector embeddings of various instances of bookmark data 120, 122, 124. Comparing of vector embeddings may be performed using any suitable techniques such as, for example, Euclidian distance, cosine distance, and/or the like. If the determined distance between the vector embedding of the chat tool input message and the vector embedding of an instance of bookmark data 120, 122, 124 is less than a threshold, then the chat system 102 may determine that the identified instance of bookmark data 120, 122, 124 is responsive to the chat tool input message received at operation 402.

If an instance of bookmark data 120, 122, 124 is responsive to the chat tool input message received at operation 402, the chat system (e.g., the conversation processor 104 and/or bookmark tool 106) may, at operation 406, prompt the user to determine whether the user would like to receive a response to the chat tool input message received at operation 402 from the bookmark data 120, 122, 124 or from making a new query to the trained computerized model 110 and/or DBMS 112. This may include providing the user 126, 128 with a chat tool reply message including a prompt asking the user to select whether the user would like to receive a response from the identified instance of bookmark data 120, 122, 124. If the user 126, 128 indicates permission to receive a response from the identified instance of bookmark data 120, 122, 124, the chat system 102 (e.g., the conversation processor 104 and/or bookmark tool 106) may, at operation 408, provide the user with a chat tool reply message comprising all or part of the data from the identified instance of bookmark data 120, 122, 124. For example, the chat system 102 may provide the user 126, 128 with the query response data included in the identified instance of bookmark data 120, 122, 124.

If no instance of bookmark data 120, 122, 124 is identified as being responsive to the chat tool input message at operation 404 or if the user decides not to receive a response from the bookmark data at operation 406, then the chat system 102 (e.g., the conversation processor 104) may, at operation 410, execute the trained computerized model 110 using the chat tool input message as some or all of the input to the trained computerized model 110. The trained computerized model 110 may generate an output that is based on the chat tool input message.

At operation 412, the chat system 102 determines if the output of the trained computerized model 110 indicates a query of the DBMS 112. In some examples, the output of the trained computerized model 110 may indicate a query of the DBMS 112 and/or may comprise user question text describing a question to be posed to the user 126. For example, user question text may prompt the user to provide additional information that may be used to by the trained computerized model to determine or suggest the query of the DBMS 112. If the output of the trained computerized model 110 indicates user question text, the user question text may be provided to the user vi a chat tool reply message. If the output of the trained computerized model 110 does not indicate a query of the DBMS 112, the chat system 102 may, at operation 413, wait for a next chat tool input message from the user 126, 128. The next chat tool input message, when received, may be processed as described with respect to operation 402.

If the output of the trained computerized model 110 does indicate a query of the DBMS, the chat system 102 may, at operation 414, execute the query at the DBMS 112. This may result in query response data. At operation 416, the chat system 102 (e.g. the conversation processor 104 thereof) may provide the query response data to the user 126, 128. At operation 418, the chat system 102 (e.g. the bookmark tool 106 thereof) may generate an instance of bookmark data 120, 122, 124 describing the transaction. The instance of bookmark data 120, 122, 124 may comprise the chat tool input message and the query response data. The bookmark data 120, 122, 124 may also comprise context data describing the interaction between the user and the chat system 102 that resulted in the query. This may include, for example, data describing the user 126, 128 and data describing the user computing device 130, 132, chat tool client 134, 136, or other system through which the user 126, 128 accessed the chat system 102. The context data may also describe, for example, a role associated with the user, a date of the chat tool input message, a time of the chat tool input message, a location of the user, and/or the like.

At operation 420, the chat system 102 (e.g., the bookmark tool 106 thereof) may store the instance of bookmark data 120, 122, 124 generated at operation 418. In some examples, this includes initially storing the bookmark data 120, 122, 124 at short-term storage 118. Depending on the response of the user 126, 128 to the query response data, the bookmark tool 106 may then move the bookmark data 120, 122, 124 to long-term storage 107 and/or delete it.

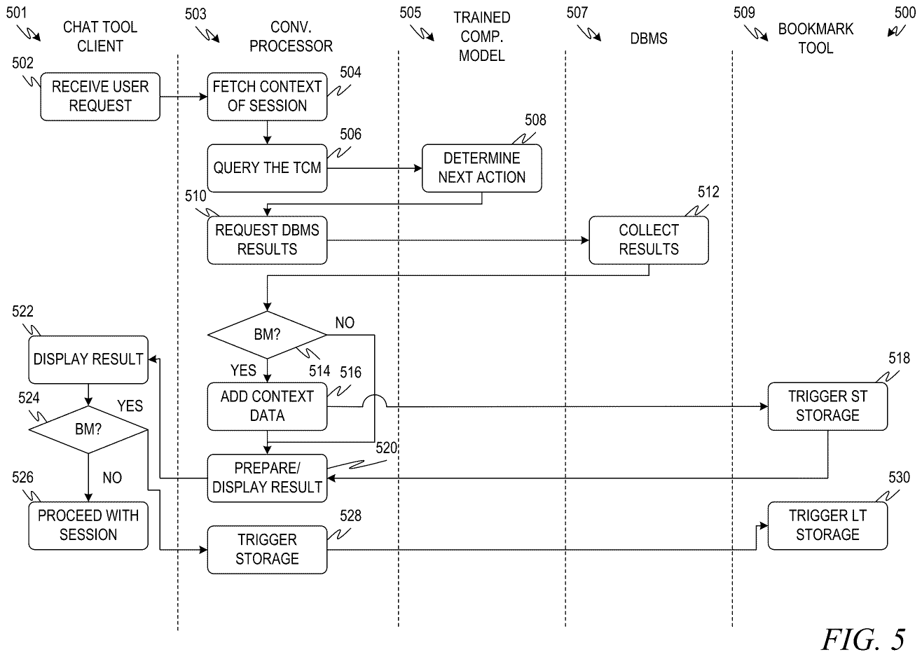

FIG. 5 is a flowchart showing one example of a process flow 500 that may be executed in the environment 100 of FIG. 1 to respond to a chat tool input message from a user by storing bookmark data. FIG. 5 comprises columns 501, 503, 505, 507, 509 indicating operations performed by different components of the environment 100 of FIG. 1. Operations in column 501 may be performed by the chat tool client 134, 136 that may be executing at a user computing device 130, 132 of a respective user 126, 128. Operations in column 503 may be performed by the conversation processor 104 or other component of the chat system 102. Operations in column 505 may be performed by the trained computerized model 110. Operations in column 507 may be performed by the DBMS 112 and or another component of the ERP system 108 such as, for example, one or more of the ERP applications 114, 116. Operations in column 509 may be performed by the bookmark tool 106 and/or another component of the chat system 102.

At operation 502, the chat tool client 134, 136 may receive a chat tool input message from a user 126, 128. The chat tool input message may be provided to the chat system 102 (e.g., the conversation processor 104). At operation 504, the chat system 102 (e.g., the conversation processor 104) may fetch the context of the current chat session. This may include gathering messages (e.g., chat tool input messages and chat tool input message replies) that have been exchanged between the chat system 102 and the user 126, 128 during a current session. The context may also include any queries to the DBMS 112 made during the current session as well as query results, whether or not provided to the user.

At operation 506, the chat system 102 (e.g., the conversation processor 104) may execute the trained computerized model 110 using at least the chat tool input message received at operation 502. In some examples, the trained computerized model 110 is executed using some or all of the context data gathered at operation 504 in addition to the chat tool input message received at operation 502. The chat tool input message received at operation 502 and/or some or all of the context data gathered at operation 504 may be provided as input to the trained computerized model 110.

The trained computerized model 110 may execute at operation 508 to determine a next action. The next action may include, for example, querying the DBMS 112, and/or posing a question to the user 126, 128 to prompt the user 126, 128 to provide additional information. In some examples, the trained computerized model 110 may provide an output including question text data describing a question to be provided to the user via a chat tool reply message. In the example of FIG. 5, the next action determined that 508 includes querying the DBMS 112.

At operation 510, the chat system 102 (e.g., the conversation processor 104) queries the DBMS 112 using the output of the trained computerized model 110 determined at operation 508. For example, the output of the trained computerized model 110 may comprise a query to be directed to the DBMS 112. It will be appreciated that, in some examples, the chat system 102 make query the DBMS 112 through one or more of the ERP applications 114, 116. For example, the chat system 102 may provide a request generated by the trained computerized model 110 to an ERP application 114, 116. The ERP application 114, 116 may respond to the request by querying the DBMS 112.

At operation 512, the DBMS 112 returns query response data describing a response to the query provided to the DBMS directly or indirectly at operation 510. At operation 514, the chat system 102 (e.g., the conversation processor 104) determines whether to generate an instance of bookmark data based on the query response data generated by the DBMS 112 in response to the query. In some examples, this may include determining whether any response was generated. If a response to the query was generated, then the response may be used to generate an instance of bookmark data. In other examples, this may include determining whether the response threshold criteria such as, for example, a predetermined size.

If the chat system 102 determines to generate bookmark data, it may add context data to the DBMS query response data at operation 516. The chat system 102 (e.g., the bookmark tool 106) may store the DBMS query response data and context data to short-term storage 118 at operation 518.

At operation 520, the chat system 102 (e.g., the conversation processor 104) may prepare and display the query result data. This may include incorporating the query result data into a chat tool reply message that is provided to the user 126, 128. The chat tool reply message may be displayed to the user 126, 128 at operation 522 via the chat tool client 134, 136 and user computing device 130, 132.

At operation 524, the chat tool client 134, 136 and/or chat system 102 determines whether to proceed with a bookmark of the query result data. This may include monitoring a reaction of the user 126, 128 to the displayed result data. For example, if the user 126, 128 interacts with the result data, it may indicate that the result data is useful for the user and should, therefore, be bookmarked. On the other hand, if the user 126, 128 sends an additional chat tool input message, such as a chat tool input message requesting additional data, it may indicate that the user did not find the result data useful.

If the chat tool client 134, 136 and/or chat system 102 determines to proceed with bookmarking the query result data, it may, at operation 528, trigger the bookmark tool 106 to move the instance of bookmark data stored at operation 518 to long-term storage. The bookmark tool 106 may move the instance of bookmark data stored at operation 518 to long-term storage at operation 530. This may include, for example, discarding the instance of bookmark data stored at operation 518 from short-term storage. If the chat tool client 134, 136 and/or chat system 102 determines to proceed with bookmarking the query result data, it may, at operation 526, it may proceed with the current session with the user 126, 128. This may include, for example, receiving additional user requests such as described with respect to operation 502.

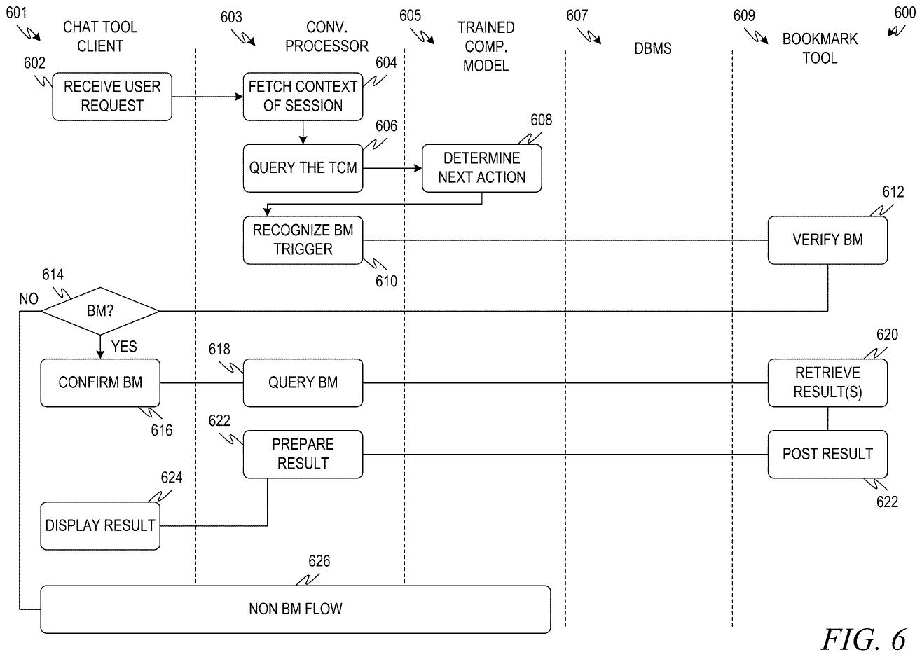

FIG. 6 is a flowchart showing one example of a process flow 600 that may be executed in the environment 100 of FIG. 1 to respond to a chat tool input message with stored bookmark data. FIG. 6 comprises columns 601, 603, 605, 607, 609 indicating operations performed by different components of the environment 100 of FIG. 1. Operations in column 601 may be performed by the chat tool client 134, 136 that may be executing at a user computing device 130, 132 of a respective user 126, 128. Operations in column 603 may be performed by the conversation processor 104 or other component of the chat system 102.

Operations in column 605 may be performed by the trained computerized model 110. Operations in column 607 may be performed by the DBMS 112 and or another component of the ERP system 108 such as, for example, one or more of the ERP applications 114, 116. Operations in column 609 may be performed by the bookmark tool 106 and/or another component of the chat system 102.

At operation 602, the chat tool client 134, 136 may receive a chat tool input message from a user 126, 128. The chat tool input message may be provided to the chat system 102 (e.g., the conversation processor 104). At operation 604, the chat system 102 (e.g., the conversation processor 104) may fetch the context of the current chat session. This may include gathering messages (e.g., chat tool input messages and chat tool input message replies) that have been exchanged between the chat system 102 and the user 126, 128 during a current session. The context may also include any queries to the DBMS 112 made during the current session as well as query results, whether or not provided to the user. The context may also include any information about the user 126 or 128 involved in the chat such as role in a company, position in the company's organizational tree, location, etc.

At operation 606, the chat system 102 (e.g., the conversation processor 104) may execute the trained computerized model 110 using at least the chat tool input message received at operation 602. In some examples, the trained computerized model 110 is executed using some or all of the context data gathered at operation 604 in addition to the chat tool input message received at operation 602. The chat tool input message received at operation 602 and/or some or all of the context data gathered at operation 604 may be provided as input to the trained computerized model 110.

The trained computerized model 110 may execute at operation 608 to determine a next action. The next action may include, for example, querying the DBMS 112, and/or posing a question to the user 126, 128 to prompt the user 126, 128 to provide additional information. In some examples, the trained computerized model 110 may provide an output including question text data describing a question to be provided to the user via a chat tool reply message. In the example of FIG. 6, the next action determines that 608 includes querying the DBMS 112.

At operation 610, the chat system 102 (e.g., the conversation processor 104) determines that the next action suggested by the output of the trained computerized model is consistent with an instance of bookmark data 120, 122, 124. This may include, for example, generating a vector embedding of the chat tool input message received at operation 602, the output of the trained computerized model determined at operation 608, and/or the like. The vector embedding may be compared to the vector embeddings of one or more instances of bookmark data 120, 122, 124, for example, as described herein.

The chat system 102 (e.g., the bookmark tool 106) may verify the identified instance of bookmark data at operation 612. This may include, for example, verifying that the determined instance of the bookmark data 120, 122, 124 is correctly stored and that it is responsive to the chat tool input message.

At operation 614, the chat tool client 134, 136 may prompt the user 126, 128, via a chat tool reply message, to indicate whether the user would like to receive query result data from the identified instance of bookmark. If the user 126, 128 indicates that the user 126, 128 would not like to receive query result data from the identified instance of the bookmark, a non-bookmark process flow may be executed at operation 626. For example, the chat system 102 (e.g., the conversation processor 104) may proceed as described beginning at the operation 510 of FIG. 5.

If the user 126, 128 indicates user permission to receive query results from the identified instance of the bookmark, for example, by confirming at operation 616, for example, by sending a chat tool input message and/or selecting an appropriate user interface (UI) element provided by the chat tool client 134, 136. In response, the chat system 102 (e.g., the conversation processor 104) may query the bookmark tool 106 to obtain the identified instance of bookmark data 120, 122, 124 at operation 618. The bookmark tool may retrieve the identified instance of bookmark data 120, 122, 124 at operation 620 and post it to the conversation processor 104 at operation 622. The conversation processor 104 may prepare a chat tool reply message that may include, for example, identifying query response data from the identified instance of bookmark data 120, 122, 124 and preparing a chat tool reply message comprising the query response data. The chat tool response message may be displayed to the user 126, 128 at operation 624.

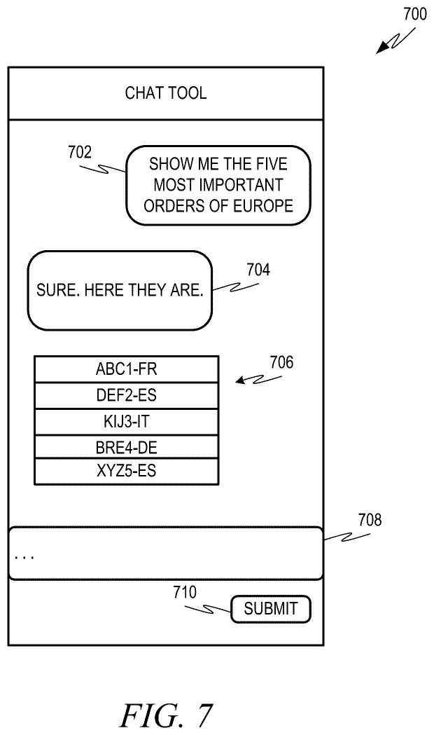

FIG. 7 is a diagram showing one example of a user interface screen 700 that may be provided to a user 126, 128 by the chat system 102. The user interface screen 700 includes messages 702, 704, 706 making up all or part of a chat session between the user 126, 128 and the chat system 102. The screen 700 may be provided to the user 126, 128, via a chat tool client 134, 136. The user interface screen 700 comprises a user input field 708 where the user 126, 128 may type or otherwise input chat tool input messages. When the user has completed inputting a chat tool input message, the user may select the submit button 710 to provide the chat tool input message to the chat system 102.

In the example of FIG. 7, the user 126, 128 has provided a chat tool input message 702 of “show me the five most important orders of Europe.” The chat tool input message 702 is provided to the conversation processor 104. The conversation processor 104, in turn, provides the chat tool input message 702 to the trained computerized model 110. In this example, the trained computerized model 110 may respond by providing the conversation processor 104 with a query that, when executed at the DBMS 112, returned the five most important orders of Europe. The conversation processor 104 may execute the query at the DBMS and receive query response data. The conversation processor 104 may provide the user 126, 128 with the chat tool reply messages 704, 706. The chat tool reply message 704 indicates that the results of the user's request are to be provided. The chat tool reply message 706 comprises query response data in response to the chat tool input message 702. In this example, the chat tool reply message 706 describes the orders requested by the chat tool input message 702. In some examples, the indications of orders in the chat tool reply message 706 are selectable by the user 126, 128. When the user 126, 128 selects an indication of an order in the chat tool reply message 706, one or more of the ERP applications 114, 116 may launch on the user's user computing device 130, 132. This may enable the user to view and/or modify data describing the selected order.

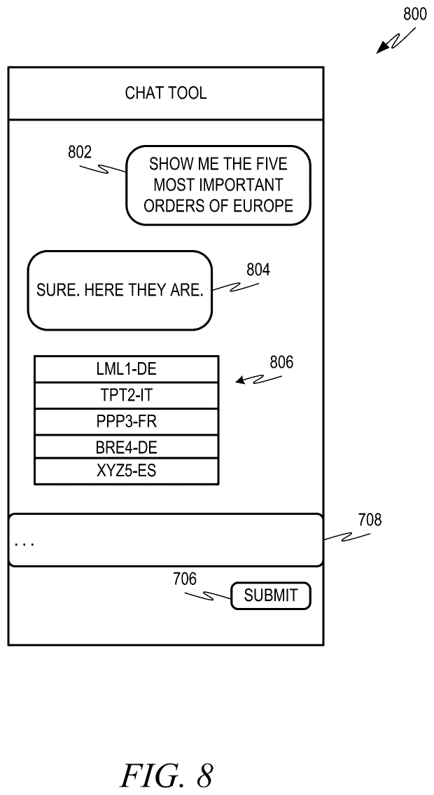

FIG. 8 is a diagram showing one example of a user interface screen 800 that may be provided to a user 126, 128 by the chat system 102. The user interface screen 800 illustrates a response to a chat tool input message 802 that is the same as the chat tool input message 702 of FIG. 7, but made at a different (e.g. later) time. As illustrated, the chat system 102 may respond in a similar way including chat tool reply messages 804, 806. As illustrated, however, the chat tool reply message 806 indicates different orders than the chat tool reply message 706. This illustrates that making the same chat tool input request of the trained computerized model may not necessarily provide the same output.

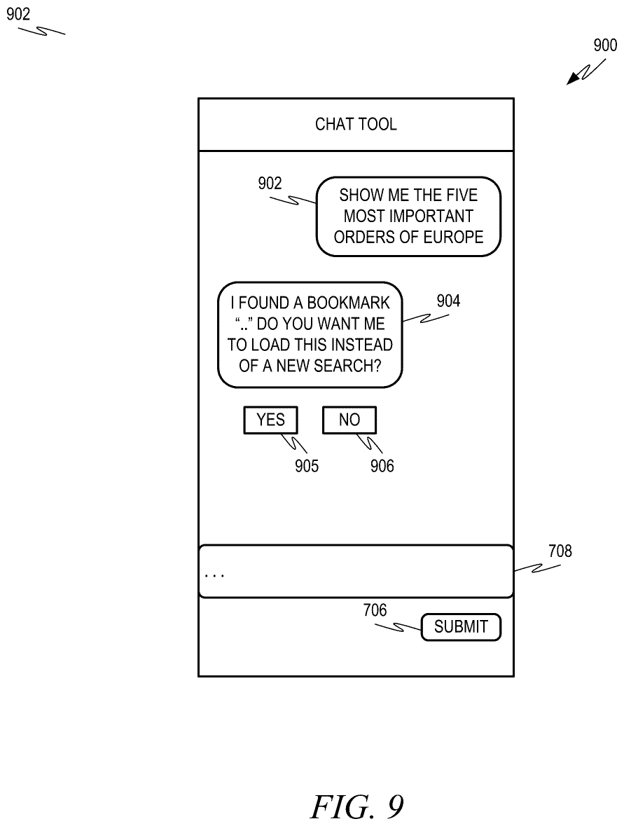

FIG. 9 is a diagram showing one example of a user interface screen 900 that may be provided to a user 126, 128 by the chat system 102. The user interface screen 900 illustrates a chat tool input message 902 for which the chat system 102 identifies a responsive instance of bookmark data. As illustrated, the chat system 102 may respond to the chat tool input message 902 with a chat tool reply message 904 prompting the user 126, 128 to indicate whether the user 126, 128 would like to load from the instance of bookmark data. Also displayed are user 126, 128 interface elements 905, 906 that may be selected by the user to indicate whether the user 126, 128 would like to load from the identified instance of bookmark data. The user may select the user interface element 905 indicate permission to load the bookmark data or select the user interface element 906 to indicate no. The user interface screen 900 as illustrated in FIG. 9 shows one example way of performing the operation 614 of the process flow 600 and/or operation 406 of the process flow 400.

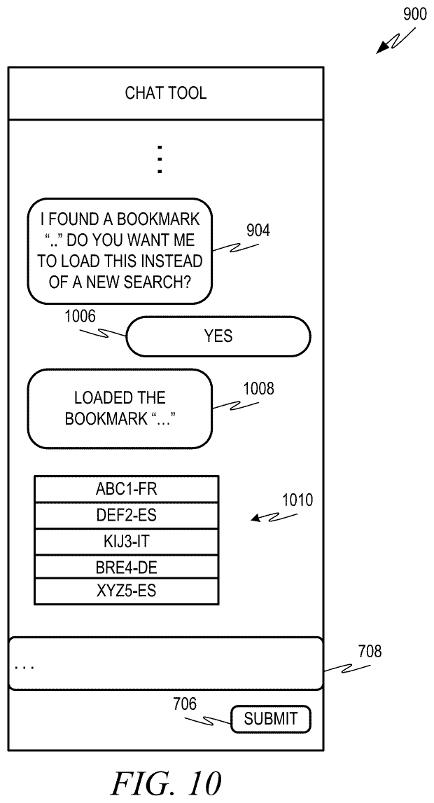

FIG. 10 is a diagram showing another example of the user interface screen 900. In the example of FIG. 10, the user 126, 128 has selected the user interface element 905 to indicate that the user would like to load the identified bookmark data. The chat system 102 provides a chat tool reply message 1008 indicating that it has loaded from the identified instance of bookmark data 120, 122, 124. An additional chat tool reply message 1010 includes query response data loaded from the identified instance of bookmark data 120, 122, 124.

In view of the disclosure above, various examples are set forth below. It should be noted that one or more features of an example, taken in isolation or combination, should be considered within the disclosure of this application.

### Examples

Example 1 is a system for querying a database management system, the system comprising: at least one processor programmed to perform operations comprising: receiving a first chat tool input message from a user; providing the first chat tool input message as input to a trained computerized model; determining that a first output of the trained computerized model indicates a first query to the database management system, the first output of the trained computerized model being based on the first chat tool input message; receiving, from the database management system, first query response data in response to the first query; based on the determining that the first output of the trained computerized model indicates the first query to the database management system, generating first bookmark data, the first bookmark data comprising the first chat tool input message, the first query response data, and user metadata describing the user; receiving a second chat tool input message from the user; determining, based at least in part on the second chat tool input message, that the first bookmark data is responsive to the second chat tool input message; and sending a second chat tool reply message to the user, the second chat tool reply message comprising at least a portion of the first bookmark data.

In Example 2, the subject matter of Example 1 optionally includes the operations further comprising: storing the first bookmark data at a short-term storage location; sending a first chat tool reply message to the user, the first chat tool reply message comprising at least a portion of the first query response data; receiving a subsequent user input from the user, the subsequent user input being responsive to the first output of the trained computerized model; based at least on the subsequent user input, determining to store the first bookmark data at a long-term storage location; storing the first bookmark data at the long-term storage location; and clearing the first bookmark data from the short-term storage location.

In Example 3, the subject matter of Example 2 optionally includes the operations further comprising: receiving a third chat tool input message from a user; providing the third chat tool input message as input to the trained computerized model to generate a second output of the trained computerized model; based on determining that the second output of the trained computerized model indicates a second query to the database management system, generating second bookmark data, the second bookmark data comprising the third chat tool input message, second query response data generated by the database management system, and the user metadata describing the user; storing the second bookmark data at the short-term storage location; receiving a second subsequent input from the user, the second subsequent input being responsive to the second query response data; based at least on the second subsequent input from the user, determining to delete the second bookmark data; and deleting the second bookmark data from the short-term storage location.

In Example 4, the subject matter of any one or more of Examples 2-3 optionally include the operations further comprising executing a second trained computerized model based at least in part on the subsequent user input, the determining to store the first bookmark data at the long-term storage location being based at least in part on an output of the second trained computerized model.

In Example 5, the subject matter of any one or more of Examples 1-4 optionally include the first bookmark data further comprising at least one prior chat tool input message received from the user prior to the first chat tool input message.

In Example 6, the subject matter of any one or more of Examples 1-5 optionally include the user metadata describing at least one of a role of the user, a location of the user, or a source system from which the user provided the first chat tool input message.

In Example 7, the subject matter of any one or more of Examples 1-6 optionally include the operations further comprising: generating a vector embedding of the first bookmark data; and generating a vector embedding of the second chat tool input message, the determining that the first bookmark data is responsive to the second chat tool input message comprising comparing the vector embedding of the first bookmark data and the vector embedding of the second chat tool input message.

In Example 8, the subject matter of any one or more of Examples 1-7 optionally include the operations further comprising: generating a vector embedding of the first bookmark data; and storing the first bookmark data at a location determined at least in part based on the vector embedding of the first bookmark data.

In Example 9, the subject matter of any one or more of Examples 1-8 optionally include the operations further comprising: before sending the second chat tool reply message to the user, sending the user a chat tool reply message requesting user permission to receive the first bookmark data; and receiving, from the user, an indication of permission to receive the first bookmark data.

Example 10 is a method for querying a database management system, the method comprising: receiving a first chat tool input message from a user; providing the first chat tool input message as input to a trained computerized model; determining that a first output of the trained computerized model indicates a first query to the database management system, the first output of the trained computerized model being based on the first chat tool input message; receiving, from the database management system, first query response data in response to the first query; based on the determining that the first output of the trained computerized model indicates the first query to the database management system, generating first bookmark data, the first bookmark data comprising the first chat tool input message, the first query response data, and user metadata describing the user; receiving a second chat tool input message from the user; determining, based at least in part on the second chat tool input message, that the first bookmark data is responsive to the second chat tool input message; and sending a second chat tool reply message to the user, the second chat tool reply message comprising at least a portion of the first bookmark data.

In Example 11, the subject matter of Example 10 optionally includes storing the first bookmark data at a short-term storage location; sending a first chat tool reply message to the user, the first chat tool reply message comprising at least a portion of the first query response data; receiving a subsequent user input from the user, the subsequent user input being responsive to the first output of the trained computerized model; based at least on the subsequent user input, determining to store the first bookmark data at a long-term storage location; storing the first bookmark data at the long-term storage location; and clearing the first bookmark data from the short-term storage location.

In Example 12, the subject matter of Example 11 optionally includes receiving a third chat tool input message from a user; providing the third chat tool input message as input to the trained computerized model to generate a second output of the trained computerized model; based on determining that the second output of the trained computerized model indicates a second query to the database management system, generating second bookmark data, the second bookmark data comprising the third chat tool input message, second query response data generated by the database management system, and the user metadata describing the user; storing the second bookmark data at the short-term storage location; receiving a second subsequent input from the user, the second subsequent input being responsive to the second query response data; based at least on the second subsequent input from the user, determining to delete the second bookmark data; and deleting the second bookmark data from the short-term storage location.

In Example 13, the subject matter of any one or more of Examples 11-12 optionally include executing a second trained computerized model based at least in part on the subsequent user input, the determining to store the first bookmark data at the long-term storage location being based at least in part on an output of the second trained computerized model.

In Example 14, the subject matter of any one or more of Examples 10-13 optionally include the first bookmark data further comprising at least one prior chat tool input message received from the user prior to the first chat tool input message.

In Example 15, the subject matter of any one or more of Examples 10-14 optionally include the user metadata describing at least one of a role of the user, a location of the user, or a source system from which the user provided the first chat tool input message.

In Example 16, the subject matter of any one or more of Examples 10-15 optionally include generating a vector embedding of the first bookmark data; and generating a vector embedding of the second chat tool input message, the determining that the first bookmark data is responsive to the second chat tool input message comprising comparing the vector embedding of the first bookmark data and the vector embedding of the second chat tool input message.

In Example 17, the subject matter of any one or more of Examples 10-16 optionally include generating a vector embedding of the first bookmark data; and storing the first bookmark data at a location determined at least in part based on the vector embedding of the first bookmark data.

In Example 18, the subject matter of any one or more of Examples 10-17 optionally include before sending the second chat tool reply message to the user, sending the user a chat tool reply message requesting user permission to receive the first bookmark data; and receiving, from the user, an indication of permission to receive the first bookmark data.

Example 19 is a non-transitory machine-readable medium comprising instructions thereon that, when executed by at least one processor, cause the at least one processor to perform operations comprising: receiving a first chat tool input message from a user; providing the first chat tool input message as input to a trained computerized model; determining that a first output of the trained computerized model indicates a first query to a database management system, the first output of the trained computerized model being based on the first chat tool input message; receiving, from the database management system, first query response data in response to the first query; based on the determining that the first output of the trained computerized model indicates the first query to the database management system, generating first bookmark data, the first bookmark data comprising the first chat tool input message, the first query response data, and user metadata describing the user; receiving a second chat tool input message from the user; determining, based at least in part on the second chat tool input message, that the first bookmark data is responsive to the second chat tool input message; and sending a second chat tool reply message to the user, the second chat tool reply message comprising at least a portion of the first bookmark data.

In Example 20, the subject matter of Example 19 optionally includes the operations further comprising: storing the first bookmark data at a short-term storage location; sending a first chat tool reply message to the user, the first chat tool reply message comprising at least a portion of the first query response data; receiving a subsequent user input from the user, the subsequent user input being responsive to the first output of the trained computerized model; based at least on the subsequent user input, determining to store the first bookmark data at a long-term storage location; storing the first bookmark data at the long-term storage location; and clearing the first bookmark data from the short-term storage location.

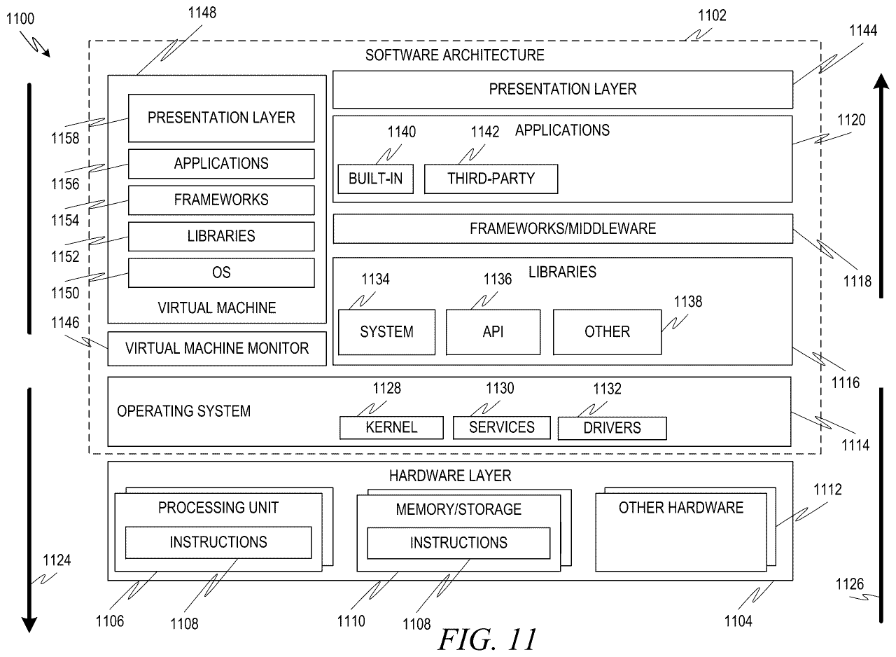

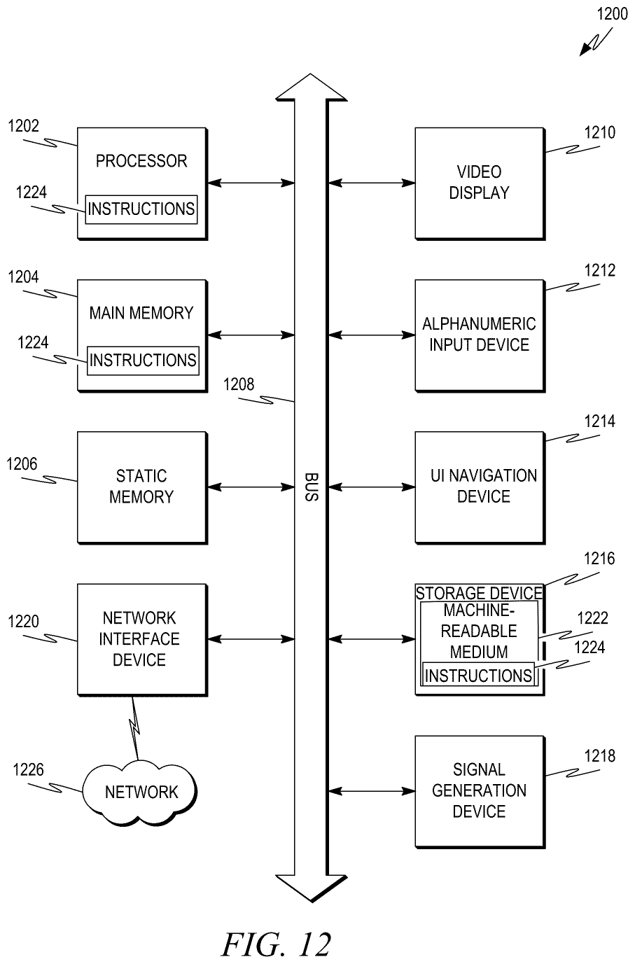

FIG. 11 is a block diagram 1100 showing one example of a software architecture 1102 for a computing device. The software architecture 1102 may be used in conjunction with various hardware architectures, for example, as described herein. FIG. 11 is merely a non-limiting example of a software architecture and many other architectures may be implemented to facilitate the functionality described herein. The software architecture 1102 and various other components described in FIG. 11 may be used to implement various other systems described herein. For example, the software architecture 1102 shows one example way for implementing the user computing devices 130, 132 and/or various computing architectures for the ERP system 108, chat system 102, trained computerized model 110, and/or the like. In FIG. 11, a representative hardware layer 1104 is illustrated and can represent, for example, any of the above-referenced computing devices. In some examples, the hardware layer 1104 may be implemented according to the architecture of the computer system of FIG. 12.

The representative hardware layer 1104 comprises one or more processing units 1106 having associated executable instructions 1108. Executable instructions 1108 represent the executable instructions of the software architecture 1102, including implementation of the methods, modules, systems, and components, and so forth described herein and may also include memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of the software architecture 1102.

In the example architecture of FIG. 11, the software architecture 1102 may be conceptualized as a stack of layers where each layer provides particular functionality. For example, the software architecture 1102 may include layers such as an operating system 1114, libraries 1116, middleware layer 1118 (sometimes referred to as frameworks), applications 1120, and presentation layer 1144. Operationally, the applications 1120 and/or other components within the layers may invoke API calls 1124 through the software stack and access a response, returned values, and so forth illustrated as messages 1126 in response to the API calls 1124. The layers illustrated are representative in nature and not all software architectures have all layers. For example, some mobile or special purpose operating systems may not provide the middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of an interrupt and, in response, cause the software architecture 1102 to pause its current processing and execute an interrupt service routine (ISR) when an interrupt is accessed.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system 1134 libraries (e.g., C standard library) that may provide functions such as memory allocation functions, string manipulation functions, mathematic functions, and/or the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 1116 may also include a wide variety of other libraries 1138 to provide many other APIs to the applications 1120 and other software components/modules.

The middleware layer 1118 (also sometimes referred to as frameworks) may provide a higher-level common infrastructure that may be utilized by the applications 1120 and/or other software components/modules. For example, the middleware layer 1118 may provide various graphic user interface (GUI) functions, high-level resource management, high-level location services, and so forth. The middleware layer 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. Third-party applications 1142 may include any of the built-in applications 1140 as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1142 may invoke the API calls 1124 provided by the mobile operating system, such as operating system 1114, to facilitate functionality described herein.

The applications 1120 may utilize built-in operating system functions (e.g., kernel 1128, services 1130 and/or drivers 1132), libraries (e.g., system 1134, API libraries 1136, and other libraries 1138), and middleware layer 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 11 illustrates by virtual machine 1148. A virtual machine creates a software environment where applications/modules can execute as if they were executing on a hardware computing device. A virtual machine 1148 is hosted by a host operating system (operating system 1114) and typically, although not always, has a virtual machine monitor 1146, which manages the operation of the virtual machine 1148 as well as the interface with the host operating system (i.e., operating system 1114). A software architecture executes within the virtual machine 1148. The software architecture may be or include, for example, an operating system 1150, libraries 1152, frameworks/middleware 1154, applications 1156 and/or presentation layer 1158. These layers of software architecture executing within the virtual machine 1148 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

FIG. 12 is a block diagram of a machine in the example form of a computer system 1200 within which instructions 1224 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation (or cursor control) device 1214 (e.g., a mouse), a storage device 1216, such as a disk drive unit, a signal generation device 1218 (e.g., a speaker), and a network interface device 1220.

The storage device 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting machine-readable media 1222.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding, or carrying instructions 1224 for execution by the machine and that cause the machine to perform any one or more of the methodologies of the present disclosure, or that is capable of storing, encoding, or carrying data structures utilized by or associated with such instructions 1224. The term “machine-readable medium” shall accordingly be taken to include, but not be limited to, solid-state memories, and optical and magnetic media. Specific examples of machine-readable media 1222 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 1224 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system for querying a database management system, the system comprising:
at least one processor programmed to perform operations comprising:
receiving a first chat tool input message from a user;
providing the first chat tool input message as input to a trained computerized model;
determining that a first output of the trained computerized model indicates a first query to the database management system, the first output of the trained computerized model being based on the first chat tool input message;
receiving, from the database management system, first query response data in response to the first query;
based at least in part on the determining that the first output of the trained computerized model indicates the first query to the database management system, generating first bookmark data, the first bookmark data comprising the first chat tool input message, the first query response data, and user metadata describing the user;
receiving a second chat tool input message from the user;
comparing the second chat tool input message to a plurality of bookmark data instances, the plurality of bookmark data instances comprising the first bookmark data:
based at least in part on the comparing, determining that the first bookmark data is responsive to the second chat tool input message; and
sending a second chat tool reply message to the user, the second chat tool reply message comprising at least a portion of the first bookmark data.

2. The system of claim 1, the operations further comprising:
storing the first bookmark data at a short-term storage location;
sending a first chat tool reply message to the user, the first chat tool reply message comprising at least a portion of the first query response data;
receiving a subsequent user input from the user, the subsequent user input being responsive to the first output of the trained computerized model;
based at least on the subsequent user input, determining to store the first bookmark data at a long-term storage location;
storing the first bookmark data at the long-term storage location; and
clearing the first bookmark data from the short-term storage location.

3. The system of claim 2, the operations further comprising:
receiving a third chat tool input message from a user;
providing the third chat tool input message as input to the trained computerized model to generate a second output of the trained computerized model;
based on determining that the second output of the trained computerized model indicates a second query to the database management system, generating second bookmark data, the second bookmark data comprising the third chat tool input message, second query response data generated by the database management system, and the user metadata describing the user;
storing the second bookmark data at the short-term storage location;
receiving a second subsequent input from the user, the second subsequent input being responsive to the second query response data;
based at least on the second subsequent input from the user, determining to delete the second bookmark data; and
deleting the second bookmark data from the short-term storage location.

4. The system of claim 2, the operations further comprising executing a second trained computerized model based at least in part on the subsequent user input, the determining to store the first bookmark data at the long-term storage location being based at least in part on an output of the second trained computerized model.

5. The system of claim 1, the first bookmark data further comprising at least one prior chat tool input message received from the user prior to the first chat tool input message.

6. The system of claim 1, the user metadata describing at least one of a role of the user, a location of the user, or a source system from which the user provided the first chat tool input message.

7. The system of claim 1, the operations further comprising:
generating a vector embedding of the first bookmark data; and
generating a vector embedding of the second chat tool input message, the determining that the first bookmark data is responsive to the second chat tool input message comprising comparing the vector embedding of the first bookmark data and the vector embedding of the second chat tool input message.

8. The system of claim 1, the operations further comprising:
generating a vector embedding of the first bookmark data; and
storing the first bookmark data at a location determined at least in part based on the vector embedding of the first bookmark data.

9. The system of claim 1, the operations further comprising:
before sending the second chat tool reply message to the user, sending the user a chat tool reply message requesting user permission to receive the first bookmark data; and
receiving, from the user, an indication of permission to receive the first bookmark data.

10. A method for querying a database management system, the method comprising:
receiving a first chat tool input message from a user;
providing the first chat tool input message as input to a trained computerized model;
determining that a first output of the trained computerized model indicates a first query to the database management system, the first output of the trained computerized model being based on the first chat tool input message;
receiving, from the database management system, first query response data in response to the first query;
based at least in part on the determining that the first output of the trained computerized model indicates the first query to the database management system, generating first bookmark data, the first bookmark data comprising the first chat tool input message, the first query response data, and user metadata describing the user;
receiving a second chat tool input message from the user;
comparing the second chat tool input message to a plurality of bookmark data instances, the plurality of bookmark data instances comprising the first bookmark data;
based at least in part on the comparing, determining that the first bookmark data is responsive to the second chat tool input message; and
sending a second chat tool reply message to the user, the second chat tool reply message comprising at least a portion of the first bookmark data.

11. The method of claim 10, further comprising:
storing the first bookmark data at a short-term storage location;
sending a first chat tool reply message to the user, the first chat tool reply message comprising at least a portion of the first query response data;
receiving a subsequent user input from the user, the subsequent user input being responsive to the first output of the trained computerized model;
based at least on the subsequent user input, determining to store the first bookmark data at a long-term storage location;
storing the first bookmark data at the long-term storage location; and
clearing the first bookmark data from the short-term storage location.

12. The method of claim 11, further comprising:
receiving a third chat tool input message from a user;
providing the third chat tool input message as input to the trained computerized model to generate a second output of the trained computerized model;
based on determining that the second output of the trained computerized model indicates a second query to the database management system, generating second bookmark data, the second bookmark data comprising the third chat tool input message, second query response data generated by the database management system, and the user metadata describing the user;
storing the second bookmark data at the short-term storage location;
receiving a second subsequent input from the user, the second subsequent input being responsive to the second query response data;
based at least on the second subsequent input from the user, determining to delete the second bookmark data; and
deleting the second bookmark data from the short-term storage location.

13. The method of claim 11, further comprising executing a second trained computerized model based at least in part on the subsequent user input, the determining to store the first bookmark data at the long-term storage location being based at least in part on an output of the second trained computerized model.

14. The method of claim 10, the first bookmark data further comprising at least one prior chat tool input message received from the user prior to the first chat tool input message.

15. The method of claim 10, the user metadata describing at least one of a role of the user, a location of the user, or a source system from which the user provided the first chat tool input message.

16. The method of claim 10, further comprising:
generating a vector embedding of the first bookmark data; and
generating a vector embedding of the second chat tool input message, the determining that the first bookmark data is responsive to the second chat tool input message comprising comparing the vector embedding of the first bookmark data and the vector embedding of the second chat tool input message.

17. The method of claim 10, further comprising:
generating a vector embedding of the first bookmark data; and
storing the first bookmark data at a location determined at least in part based on the vector embedding of the first bookmark data.

18. The method of claim 10, further comprising:
before sending the second chat tool reply message to the user, sending the user a chat tool reply message requesting user permission to receive the first bookmark data; and
receiving, from the user, an indication of permission to receive the first bookmark data.

19. A non-transitory machine-readable medium comprising instructions thereon that, when executed by at least one processor, cause the at least one processor to perform operations comprising:
receiving a first chat tool input message from a user;
providing the first chat tool input message as input to a trained computerized model;
determining that a first output of the trained computerized model indicates a first query to a database management system, the first output of the trained computerized model being based on the first chat tool input message;
receiving, from the database management system, first query response data in response to the first query;
based at least in part on the determining that the first output of the trained computerized model indicates the first query to the database management system, generating first bookmark data, the first bookmark data comprising the first chat tool input message, the first query response data, and user metadata describing the user;
receiving a second chat tool input message from the user;
comparing the second chat tool input message to a plurality of bookmark data instances, the plurality of bookmark data instances comprising the first bookmark data;
based at least in part on the comparing, determining that the first bookmark data is responsive to the second chat tool input message; and
sending a second chat tool reply message to the user, the second chat tool reply message comprising at least a portion of the first bookmark data.

20. The non-transitory machine-readable medium of claim 19, the operations further comprising:
storing the first bookmark data at a short-term storage location;
sending a first chat tool reply message to the user, the first chat tool reply message comprising at least a portion of the first query response data;
receiving a subsequent user input from the user, the subsequent user input being responsive to the first output of the trained computerized model;
based at least on the subsequent user input, determining to store the first bookmark data at a long-term storage location;
storing the first bookmark data at the long-term storage location; and
clearing the first bookmark data from the short-term storage location.
